(19) United States
(12) Patent Application Publication
(10) Pub. No.: US 2020/0400218 A1
(43) Pub. Date: Dec. 24, 2020

(54) RETENTION OF CHAIN TENSIONER PISTON

(71) Applicant: BorgWarner Inc., Auburn Hills, MI (US)

(72) Inventors: Paul FREEMANTLE, Lansing, NY (US); Allen R. GALLOW, Groton, NY (US); Ron MIELBRECHT, Ithaca, NY (US)

(21) Appl. No.: 16/956,793

(22) PCT Filed: Jan. 10, 2018
(86) PCT No.: PCT/US2018/013053

§ 371 Date: Jun. 22, 2020

(51) Int. Cl. F16H 7/08; F01L 1/02

(52) U.S. Cl. CPC F16H 7/0848; F01L 1/022; F16H 2007/0806; F16H 2007/0874; F16H 2007/0859; F16H 2007/0855

(57) ABSTRACT

A camshaft chain tensioner, comprising: a piston having an exterior circumferential surface that includes at least one groove; an expandable clip, positioned around the exterior circumferential surface, that includes a first end and a second end, the expandable clip being expandable from a resting diameter to an expanded diameter, wherein the expandable clip existing in the resting diameter engages one of the grooves and prevents axial movement of the piston and wherein the expandable clip existing in the expanded diameter permits axial movement of the piston in response to an axial force exerted on the piston; and a clip retention device that releasably engages the expandable clip and inhibits radially outward expansion of the expandable clip to the expanded diameter of the expandable clip.

### TECHNICAL FIELD

The present application relates to chain tensioner assemblies and, more particularly, to preventing axial movement of a piston of a chain tensioner assembly when the chain tensioner assembly is not installed for use in a vehicle.

### BACKGROUND

A chain can be used for translating rotational force between shafts through use of gears and/or sprockets. For example, an internal combustion engine (ICE) of a vehicle can include a crankshaft that is used to create rotational force that ultimately drives one or more wheels of the vehicle. The crankshaft can be synchronized with a camshaft that actuates a series of valves for use in engine piston operation, such as through allowing an air-fuel mixture to flow into a combustion chamber of the ICE that can thereafter be ignited to drive a piston of the engine. The crankshaft and camshaft can be timed using sprockets and a timing chain or timing belt connecting the respective shafts. However, the timing chain can become worn over time, and may expand or stretch, which can result in engine failure due to the timing chain disengaging from the sprockets on either or both of the camshaft or the crankshaft. To prevent disengagement of the chain, a chain tensioner is used that exerts a force onto the chain thereby tensioning or taking up slack of the chain.

### SUMMARY

In one embodiment, a camshaft chain tensioner is provided, which includes: a piston having an exterior circumferential surface that includes at least one groove; an expandable clip, positioned around the exterior circumferential surface, that includes a first end and a second end, the expandable clip being expandable from a resting diameter to an expanded diameter, wherein the expandable clip existing in the resting diameter engages one of the grooves and prevents axial movement of the piston and wherein the expandable clip existing in the expanded diameter permits axial movement of the piston in response to an axial force exerted on the piston; and a clip retention device that releasably engages the expandable clip and inhibits radially outward expansion of the expandable clip to the expanded diameter of the expandable clip.

In another embodiment, a camshaft chain tensioner is provided, which includes: a piston having an exterior circumferential surface that includes a plurality of grooves, the plurality of grooves each including a minimum diameter and a maximum diameter; an expandable clip, controlling axial movement of the piston, that includes a first end and a second end, the expandable clip being expandable from a resting diameter to an expanded diameter, wherein the resting diameter is equal to or larger than the minimum diameter and smaller than the maximum diameter, and wherein the expanded diameter is equal to or exceeds the maximum diameter; and a clip retention device that engages the expandable clip either at an overlapping region of the expandable clip or at both the first end and the second end of the expandable clip, wherein the clip retention device engages the expandable clip such that the expandable clip is prevented from expanding to or exceeding the expanded diameter of the expandable clip.

In yet another embodiment, a method of inhibiting axial movement of a piston of a camshaft chain tensioner is provided, which includes the steps of placing an expandable clip around an exterior circumferential surface of a piston, the exterior circumferential surface including a plurality of engagement grooves among which the expandable clip is placed, wherein the expandable clip includes a first end and a second end, and wherein the expandable clip is expandable from a resting diameter to an expanded diameter; and engaging the expandable clip with a clip retention device either at an overlapping region of the expandable clip or at both the first end region and the second end region of the expandable clip such that the expandable clip is prevented from expanding to the expanded diameter.

### BRIEF DESCRIPTION OF THE DRAWINGS

FIG. 1 is a profile view depicting an implementation of a chain tensioning system;

FIG. 2 is a cross-sectional perspective view depicting an implementation of a portion of a chain tensioning assembly;

FIG. 3 is a profile view depicting an implementation of a first embodiment of an expandable clip of a chain tensioning assembly existing in a resting diameter;

FIG. 4 is a profile view depicting an implementation of the first embodiment of an expandable clip of a chain tensioning assembly existing in an expanded diameter;

FIG. 5 is a profile view depicting an implementation of a second embodiment of an expandable clip of a chain tensioning assembly;

FIG. 6 is a profile view depicting an implementation of a third embodiment of an expandable clip of a chain tensioning assembly;

FIG. 7 is a profile view depicting an implementation of a fourth embodiment of an expandable clip of a chain tensioning assembly;

FIG. 8 is a profile view depicting an implementation of a fifth embodiment of an expandable clip of a chain tensioning assembly;

FIG. 9 is a perspective view depicting an implementation of a first embodiment of a clip retention device;

FIG. 10 is a perspective view depicting an implementation of a second embodiment of a clip retention device;

FIG. 11 is a profile view depicting an implementation of the first embodiment of the clip retention device engaged to the first embodiment of the expandable clip;

FIG. 12 is a profile view depicting an implementation of a clip retention device engaged to the second embodiment of the expandable clip; and

FIG. 13 is a view depicting an implementation of the second embodiment of the clip retention device engaged to the fifth embodiment of the expandable clip.

### DETAILED DESCRIPTION

A system and method of restricting or preventing axial movement of a piston in a camshaft chain tensioner is provided, including a clip retention device that restricts an expandable clip, which substantially encircles the piston, from expanding. The camshaft chain tensioner assembly includes the expandable clip that, during operation of the tensioner assembly within an internal combustion engine (ICE), allows the piston to extend so that the piston applies a force to a timing chain thereby taking up slack and preventing disengagement of the timing chain from its respective sprockets. The camshaft chain tensioner assembly can include a piston that is retained at least partly within a piston bore and includes at least one groove, a spring that applies a force on the piston in an axial direction towards an open end of the piston bore, and an expandable clip that is positioned around the exterior circumferential surface of the piston. The expandable clip can be positioned around the exterior circumferential surface of the piston in a region corresponding to a clip movement region within the piston bore. Furthermore, the clip movement region and expandable clip can be configured together so that the expandable clip allows the piston to extend outside of the piston bore while preventing retraction of the piston within the piston bore.

At least in one embodiment, the piston can include one or more grooves that prevent the expandable clip from sliding along the piston. The expandable clip, however, can expand and move axially with respect to the piston and groove(s) during piston extension in response to the expandable clip abutting an upper shoulder of the clip movement region. The expandable clip can be radially outwardly expanded to an expanded diameter thereby allowing the expandable clip to move relative to the groove. And, during the application of piston retraction forces, the expandable clip can be moved within the clip movement region and may then abut a lower shoulder of the clip movement region, which can prevent expansion of the expandable clip to an expanded diameter. Thus, the camshaft chain tensioner assembly, including the expandable clip and clip movement region within the piston bore, can act to allow piston extension and disallow piston retraction.

Nonetheless, it may be desirable to restrict the camshaft chain tensioner piston from extending during certain times when the tensioner assembly is not installed in an ICE, such as a vehicle engine. For example, while the camshaft chain tensioner assembly is apart from an ICE, such as during shipping of the tensioner assembly, it is helpful to maintain the piston in an axially-fixed position. Thus, a camshaft chain tensioner assembly can include a clip retention device that engages the expandable clip and prevents the expansion of the expandable clip to the expanded diameter thereby preventing or inhibiting axial movement of the tensioning piston. The clip retention device can hold the expandable clip at a first and a second end of the expandable clip, and/or can hold the expandable clip at an overlapping region of the expandable clip. And, in some embodiments, the clip retention device only engages the expandable clip and not any other components. Various embodiments of the camshaft chain tensioner assembly and clip retention device are provided below, and numerous others will be appreciated by those skilled in the art in light of the discussion below.

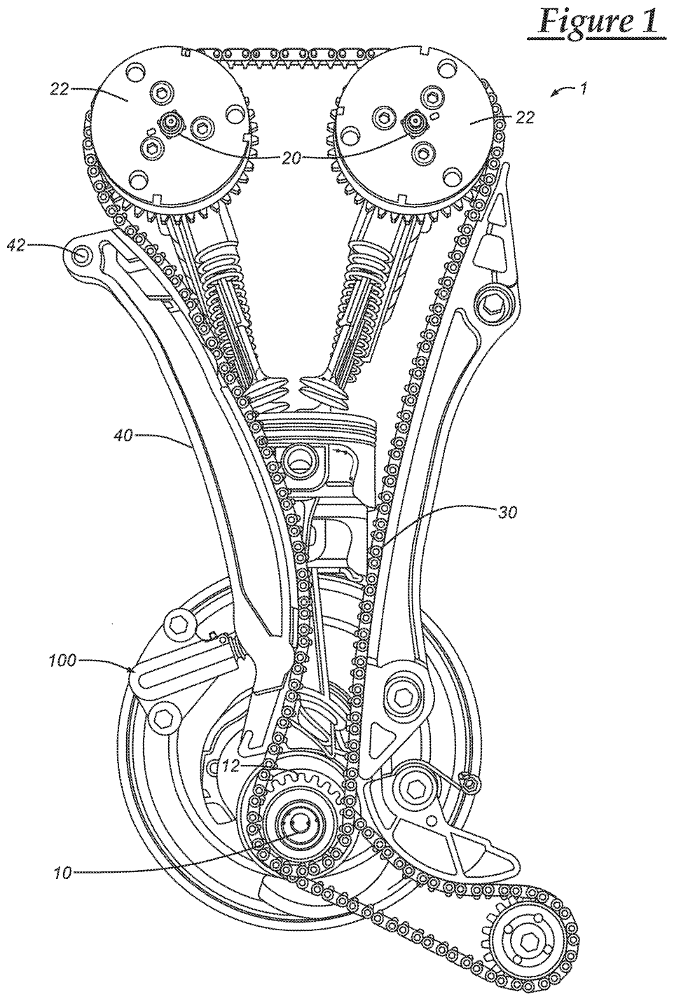

With reference to FIG. 1, a chain tensioning system 1 is shown, including a crankshaft 10, a crankshaft sprocket 12, camshafts 20, camshaft sprockets 22, a timing chain 30, a tensioning arm 40, and a camshaft chain tensioner 100. As shown, the timing chain 30 connects the crankshaft sprocket 12 and the camshaft sprockets 22, which synchronizes the timing of the crankshaft 10 and the camshafts 20. In many embodiments, the camshaft chain tensioner 100 can be a hydraulically actuated camshaft chain tensioner.

The crankshaft 10 can be connected to a plurality of connecting rods, which in turn are connected to a plurality of pistons. Each of the pistons can slide within a cylinder head and communicate with a combustion chamber, where an air-fuel mixture is provided and combusted. The combustion forces the pistons axially within the cylinders, which thereby turns the crankshaft 10. Crankshaft sprocket 12 is connected to the crankshaft 10 and, thus, rotates with the crankshaft 10. The rotational force from the crankshaft 10 can be used to rotate the camshafts 20 through use of the crankshaft sprocket 12, the camshaft sprockets 22, and the timing chain 30, which rotatably connects the crankshaft sprocket 12 and the camshaft sprockets 22.

The camshafts 20 can open and close a plurality of valves as the camshafts rotate. The rotational force from the crankshaft 10 that turns the camshafts 20 can be translated into a linear force that can be used to actuate a plurality of valves, which open and close an inlet that allows an air-fuel mixture to be introduced into the combustion chamber of the engine, as well as to open and close an outlet that allows exhaust gases to escape after combustion.

The timing chain 30 is a chain that can be used to synchronize sprocket and/or shaft operation, such as synchronizing the rotation of the crankshaft 10 and the camshafts 20. In other embodiments, the timing chain 30 can be any other chain that wears and/or stretches over time, and that is in contact with a chain tensioner component that can be used to reduce slack in the chain caused by wear. The timing chain 30 includes a plurality of chain links, each of which engage with one or more teeth on a sprocket, such as the sprockets 12 or 22.

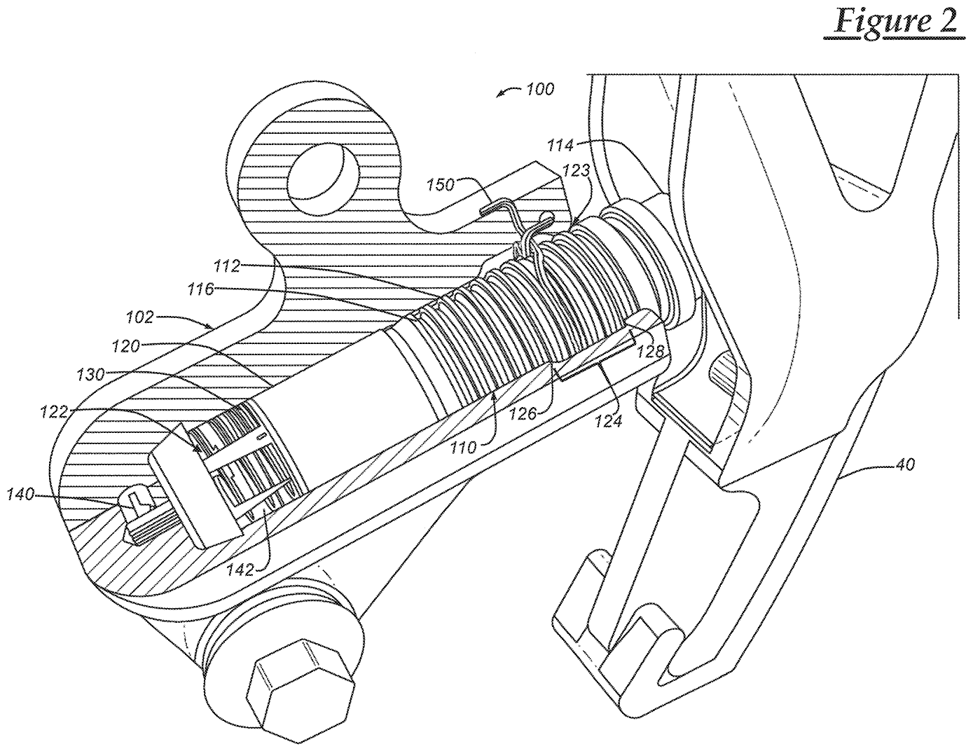

The tensioning arm 40 in the illustrated embodiment is shown as an elongated member that is curved along an interface where the arm 40 abuts the timing chain 30. The tensioning arm 40 can be moved towards the timing chain 30 so as to reduce the amount of slack in the timing chain 30. The tensioning arm 40 is moved by the chain tensioner assembly 100, which includes a tensioning piston 110 (FIG. 2) that can be used to move the tensioning arm 40 towards the timing chain 30. The tensioning arm 40 can include a single pivot point 42 as shown in FIG. 1, and the tensioning arm-chain interface can be curved and/or shaped in a variety of ways.

With reference to FIG. 2, there is shown a cross-sectional perspective view of a chain tensioning assembly 100 that can be installed in a vehicle internal combustion engine (ICE) (such as the one shown in FIG. 1) with a portion of the housing 102 cut-away so that the interior components can be illustrated. The camshaft chain tensioner assembly 100 includes the housing 102, the piston 110 that is at least partly retained within a piston bore 120, a spring 130, a fluid channel 140, and an expandable clip 150. The housing 102 can substantially surround the piston 110 and can include an opening or cavity that enables protruding ends of the expandable clip 150 to move relative to the housing 102 and the piston bore 110. As mentioned previously, the chain tensioning assembly 100 can be used to apply force via the piston 110 to the tensioning arm 40 thereby reducing the amount of slack of the chain 30. The piston 110 is at least partly retained in the piston bore 120 and the spring 130 applies a force on the piston 110 in the direction toward the tensioning arm 40, which is in turn abutted against the timing chain 30. Thus, when slack is introduced into the timing chain 30 through wear of the timing chain increasing chain length, the slack can be reduced by the piston 110 being forced by the spring 130 into the tensioning arm 40.

The spring 130 can include a first end that is positioned toward the bottom 122 of the piston bore 120 and that abuts the bottom of the piston bore 120. A second end of the spring 130 can abut an end portion of piston 110, such as the underside of the piston head 114, or another component such that the piston 110 is forced out of the piston bore 120 and towards the tensioning arm 40. In one embodiment, the spring 130 can be a low-tension spring and can be constructed of metal alloy or similar resilient material.

The fluid channel 140 can include a path used to communicate fluids, such as oil or other hydraulic fluids, into a fluid chamber 142 that is situated at or near the bottom of the piston bore 120. Additionally, a fluid retention component 144 can be positioned between the bottom of piston bore 120 and the body of piston 110, such that the fluid chamber 142 is defined by the bottom of piston bore 120 and the piston retention component 144. In one embodiment, the fluid retention component 144 can be a part of piston 110, such as the underside of the piston head 114, and, in other embodiments, the fluid retention component 144 can be positioned between the spring 130 and the piston 110. The fluid retention component 144 acts to retain the fluid received from the fluid channel 140 within the fluid chamber 142. As the piston 110 is extended out of the piston bore 120, the volume of the fluid chamber 142 increases, which causes more fluid to be communicated through the fluid channel 140 and into the fluid chamber 142. And, in some embodiments, the fluid channel 140 can include a check valve that allows fluid to be communicated into the fluid chamber 142 when the piston extends and that prevents communication back through the fluid channel 140 thereby preventing piston retraction.

The piston 110 is shown as including a plurality of grooves 112 and a piston head 114. The piston head 114 acts as a piston-tensioning arm interface and can be coupled to the tensioning arm 40 in a variety of different ways, such as through abutment and/or mechanical attachment. The piston 110 includes grooves 112 on an exterior circumferential surface of piston 110 and, in at least one embodiment, the piston 110 can include a single groove 112 that can be positioned either near the top of the piston or near the bottom of the piston, such as near or towards the opening 123 of the piston bore 120 or the bottom 122 of the piston bore 120, respectively. The grooves 112 of the piston 110 can be formed from a reduced diameter portion of the piston that extends an axial length roughly corresponding to the cross-sectional diameter of the expandable clip 150. The grooves 112 include surfaces that extend radially inward or radially outward such that the diameters or circumferences of the piston 110 varies so that the expandable clip 150 can permit extension of the piston 110, but disallow retraction of the piston 110, as explained more below. The grooves 112 can be formed in a variety of different ways and, in one embodiment, can include angled walls that slant the exterior circumferential surface of the piston radially inward and radially outward. In another embodiment, the grooves 112 can be formed of smooth, curved indentations that are shaped to engage the expandable clip 150, which can include a curved cross-section, such as a circular or elliptical cross-section. And, in many embodiments, the grooves 112 can include asymmetrical walls that facilitate the ratcheting operation of the expandable clip along the exterior circumferential surface 116 of the piston 110. These asymmetrical walls can be slanted at different angles relative to the axial direction of the piston 110.

The piston bore 120 can include an inner diameter that is suitable for extending and retracting the piston 110 throughout. The inner diameter can correspond to a diameter of the piston 110 at an upper shoulder of the grooves 112 so that the piston 110 including the grooves 112 can axially slide within piston bore 120. Additionally, the piston bore 120 can also include a clip movement region 124 that permits the expandable clip 150 to move axially relative to the piston 110.

The expandable clip 150 engages the exterior circumferential surface 116 of the piston 110 and is positioned axially within the clip movement region 124. The expandable clip 150 can be constructed of metal or another similarly resilient material, as well as any suitable material that permits resilient expansion of the expandable clip 150 such that the clip 150 can expand to an expanded diameter. The clip 150 can also include a resting diameter that corresponds to a diameter of the exterior circumferential surface 116 of piston 110 at a region where the clip 150 engages the piston 110, such as within a groove 112. In this way, the expandable clip 150 can be configured to fit around the exterior circumferential surface 116 and, also, can be designed to fit within grooves 112.

The clip movement region 124 is a cavity within the piston bore 120 that is defined by an axial section of the piston bore 120 that includes a larger inner diameter relative to the inner diameter of other axial portions of the piston bore 120 so that axial movement of the clip 150 is permitted. Additionally, the clip movement region 124 can include a lower shoulder 126 and an upper shoulder 128. The upper shoulder 128 can include a surface that runs orthogonal to the axial axis of the piston bore 120 and, thus, when the piston 110 is extended outward from the piston bore 120, the expandable clip 150 is retained within the clip movement region 124 by the upper shoulder 128. When the piston 110 is extended, the expandable clip 150 is forced by a first groove 112 to abut the upper shoulder 128 and, when sufficient axial force is applied, the expandable clip 150 expands to an expanded diameter thereby permitting the clip 150 to move axially with respect to the groove 112 and piston 110. After moving axially relative to the groove 112, the expandable clip 150 may become positioned in another groove adjacent to and axially spaced from the first groove and may return to its resting diameter.

The lower shoulder 126 of the clip movement region 124 includes a slanted or angled wall that does not permit the expandable clip 150 to expand to the expanded diameter and, thus, prevents the expandable clip 150 from moving axially relative to the grooves 112, as well as prevents retraction of the piston 110 within the piston bore 120. When the piston 110 is forced into the piston bore 120 away from the timing chain 30, the expandable clip 150 can abut the slanted or angled wall of the lower shoulder 126 thereby compressing the expandable clip 150 between the slanted wall and the exterior circumferential surface 116 of the piston 110. Compression of the expandable clip 150 restricts expansion of the expandable clip 150 so that the piston 110 cannot be retracted further within the piston bore 120.

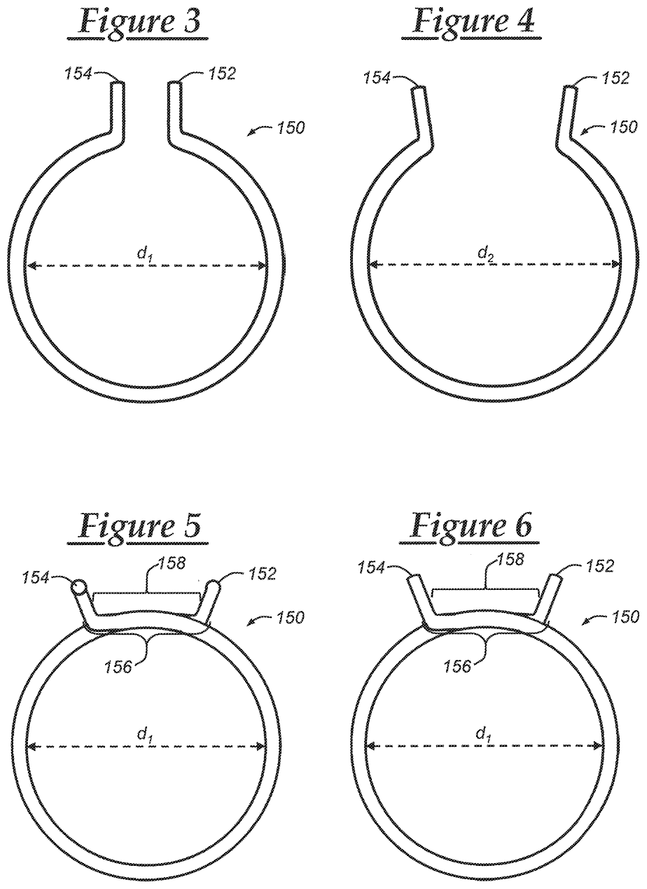

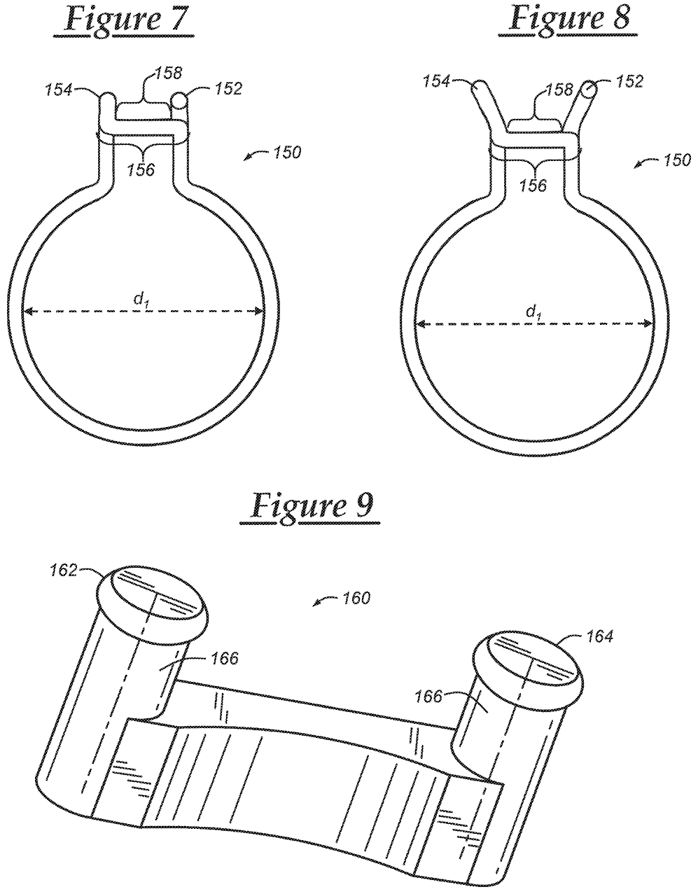

With reference to FIGS. 3 through 8, there are shown various embodiments of expandable clip 150. The expandable clip 150 can include a first end 152 and a second end 154. In at least one embodiment, the first end 152 can be bent in an axial direction of the piston 110 and pointing downwards towards the bottom 122 of the piston bore 120, whereas the second end 154 can be bent in an axial direction pointing towards the piston head 114, as illustrated in FIG. 5, as well as FIG. 2. And, as illustrated in FIGS. 5 and 6, the expandable clip 150 can also include an overlapping region 156 where portions of the expandable clip 150 circumferentially overlap and/or intersect each other. As mentioned above, the expandable clip 150 can include a resting diameter d₁ that corresponds to a diameter of the exterior circumferential surface 116 of the piston 110 at a region where the clip 150 engages the piston 110.

FIGS. 3 and 4 illustrate one embodiment of an expandable clip 150, where FIG. 3 illustrates the expandable clip 150 existing in the resting diameter d₁ and where FIG. 4 illustrates the expandable clip 150 existing in the expanded diameter d₂. The clip 150 may be expanded to the expanded diameter d₂ by axially displacing the expandable clip 150 relative to the piston 110 and one of the grooves 112 of the piston 110, which can be performed through the clip 150 abutting an inner bore wall of the piston bore 120 within a clip movement region 124 as the piston 110 moves axially.

FIGS. 5 through 8 depict other embodiments of an expandable clip 150, each of which include a first end 152, a second end 154, and an overlapping region 156 including an inner overlapping region 158. The overlapping region 156 includes those portions of the expandable clip where the elongated body of the clip 150 overlaps another portion of the elongated body, as shown in FIGS. 5 through 8. Moreover, the overlapping region 156 can include an inner overlapping region 158 that is comprised of a portion of the expandable clip 150 at the overlapping region 156 that is between a first protruding end 152 and the second protruding end 154. The clip retention device 160 engages the inner overlapping region 158 of the expandable clip 150 (FIGS. 9 through 13), as will be discussed in more detail below. Various other clips and/or ratcheting devices can be used with the chain tensioning apparatus 100, as the depicted embodiments of the expandable clip 150 in FIGS. 3 through 8 illustrate a few potential embodiments.

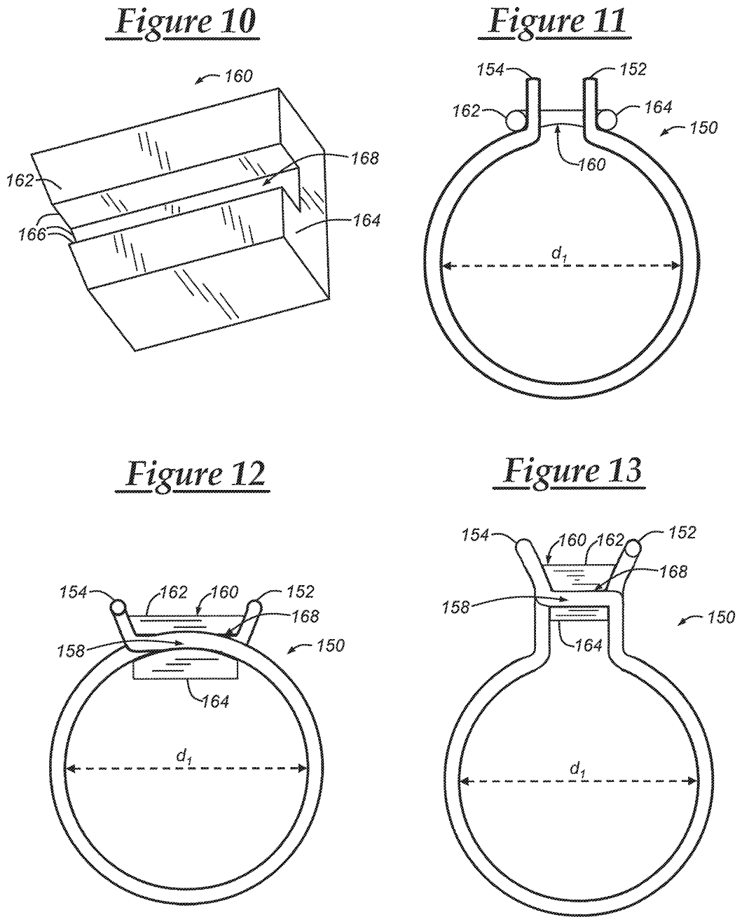

With reference to FIGS. 9 and 10, there is shown a clip retention device 160 that can be used to maintain the expandable clip 150 at its resting diameter and/or prevent the clip 150 from expanding to its expanded diameter. Thus, by preventing the expandable clip 150 from radially expanding, the clip retention device 160 can prevent the clip 150 from moving axially with respect to any of the grooves 112, which acts to prevent axial movement of the piston 110 within piston bore 120. In at least one embodiment, the clip retention device 160 can be releasably coupled to the expandable clip 150 while the chain tensioner assembly 100 is not in use—that is, during times when the chain tensioner assembly 100 is not presently incorporated into a system for application of force to a tensioning arm 40 thereby reducing slack of the chain 30. For example, when the chain tensioner assembly 100 is apart from the ICE, such as during assembly, packaging, and/or shipping, the clip retention device 160 can engage a portion of the expandable clip 150 so that the piston 110 is retained within the piston bore 120.

FIG. 9 illustrates an embodiment of the clip retention device 160 that includes a first protruding end 162, a second protruding end 164, and clip abutting surfaces 166, including a first and a second clip abutting surface. This particular clip retention device 160 can be used to prevent expansion of the expandable clip 150 by preventing displacement (and/or radially outward movement) of the first end 152 with respect to the second end 154 of the expandable clip 150. The clip retention device 160 can be comprised of an elongated member 165 that bridges the first protruding end 162 and the second protruding end 164. The first protruding end 162 and the second protruding end 164 can each extend substantially perpendicularly from the elongated member 165, and each of these ends 162-164 can include a surface that abuts the expandable clip 150 at its first end 152 and its second end 154.

FIG. 10 illustrates another clip retention device 160 that includes a first protruding end 162, a second protruding end 164, clip abutting surfaces 166, and a groove 168. As illustrated, the clip abutting surfaces 166 form a groove 168 that engages the expandable clip 150 and that prevents or inhibits movement of the first end 152 relative to the second end 154 of the expandable clip 150 thereby preventing the expandable clip 150 from expanding. The clip retention devices can include a marker or other visual indicator that is used to visually distinguish the clip retention device from other components of the camshaft chain tensioner so that an assembly technician may be more likely to notice the clip retention device when installing the chain tensioning assembly 100 into an engine or other system for which it is intended. This visual indicator can be a die used to color at least a portion of the clip retention device so as to be more noticeable—for example, the clip retention device could be colored hot pink or bright yellow.

With reference to FIGS. 11 through 13, there are shown multiple embodiments of a clip retention device 160 engaging an expandable clip 150 thereby preventing expansion of the expandable clip 150. FIG. 11 illustrates one such embodiment, where a clip retention device 160, such as the one illustrated in FIG. 9, engages the expandable clip 150 around the outer sides of a protruding first end 152 and a protruding second end 154. The clip retention device 160 prevents outward expansion of the expandable clip 150 by using the first protruding end or post 162 and the second protruding end or post 164 to prevent radially outwardly expansion of the protruding first end 152 relative to the protruding second end 154.

FIGS. 12 and 13 illustrate two embodiments of a clip retention device 160 engaging an expandable clip 150 at an inner overlapping region 158. The clip retention device 160 can include a plurality of clip abutting surfaces 166 that form a groove 168, which is shown, for example, in FIG. 10. FIG. 12 illustrates one such embodiment that includes a groove 168 that includes non-planar clip abutting surfaces 166 that form an arced or curved shape that closely conforms to the radius of the expandable clip 150. The curved groove 168 is shaped to correspond to the shape of the expandable clip 150 at the inner overlapping region 158 so that the clip retention device can be fitted snuggly around the inner overlapping region 158.

FIG. 13 illustrates another embodiment of a clip retention device 160 that engages the expandable clip 150 at an inner overlapping region 158. The inner overlapping region 158 can be linear (as shown in FIG. 13) and, accordingly, the clip retention device can include a groove that includes two opposing straight clip abutting surfaces 166, as well as an inner clip abutting surface 166 that is disposed between the two straight clip abutting surfaces 166 (such as in FIG. 10). The inner clip abutting surface 166 can be linear (as in FIG. 10) or may be arced or curved so as to correspond to the radial shape of the expandable clip 150. And, in some embodiments, the first end 162 and/or the second end 164 of the clip retention device 160 can extend outward such that the length of the two straight clip abutting surfaces 166 are longer than the combined diameters of the expandable clip 150 at the inner overlapping region 158. Additionally, the first end 162 of the clip retention device 160 can be shaped so that the first end 162 fits snuggly between the first protruding end 152 and the second protruding end 154 of the expandable clip 150.

In other embodiments, the groove 168 can be formed of a single curved clip abutting surface 166 that corresponds to the overlapping region 156 of the expandable clip 150. The curved clip abutting surface can include a cross-section that is semi-circular or substantially semi-circular and that conforms to the expandable clip 150 at the inner overlapping region 158. The groove 168 can engage an overlapping region 156 (or inner overlapping region 158) of the expandable clip 150 as well as an inner portion of the protruding first end 152 and the protruding second end 154 of the expandable clip 150. By engaging the clip retention device 160 to the expandable clip 150, the clip retention device 160 prevents movement of a first end 152 relatively closer to a second end 154 thereby preventing expansion of the expandable clip 150.

Various other embodiments of a clip retention device 160, an expandable clip 150, and a chain tensioning assembly 100 exist, as those illustrated herein are merely meant to be examples of such devices and assemblies. Different shapes, sizes, configurations, and/or arrangements of such devices or assemblies can be used, while still enabling use of a clip retention device to retain a piston within a piston bore through engaging an expandable clip that is positioned around the exterior circumferential surface of the piston.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering any one or more of the following: “A”; “B”; “C”; “A and B”; “A and C”; “B and C”; and “A, B, and C.”

What is claimed is:

1. A camshaft chain tensioner, comprising:
a piston having an exterior circumferential surface that includes at least one groove;
an expandable clip, positioned around the exterior circumferential surface, that includes a first end and a second end, the expandable clip being expandable from a resting diameter to an expanded diameter, wherein the expandable clip existing in the resting diameter engages one of the grooves and prevents axial movement of the piston and wherein the expandable clip existing in the expanded diameter permits axial movement of the piston in response to an axial force exerted on the piston; and
a clip retention device that releasably engages the expandable clip and inhibits radially outward expansion of the expandable clip to the expanded diameter of the expandable clip.

2. The camshaft chain tensioner of claim 1, further comprising a housing that includes a piston bore wherein the piston can extend out of and retract into, wherein the piston bore includes a clip movement region comprising an upper shoulder, and wherein the expandable clip is configured so that, when engaging the piston and when not engaged by the clip retention device, the expandable clip expands to the expandable diameter when the piston is forced out of the piston bore such that the expandable clip abuts the upper shoulder of the clip movement region causing the expandable clip to be forced over the at least one groove.

3. The camshaft chain tensioner of claim 2, wherein the clip movement region of the piston bore further comprises a lower shoulder such that, when the expandable clip is engaging the piston and when the expandable clip is not engaged by the clip retention device, the expandable clip is prevented from expanding to the expandable diameter when the piston is forced into the piston bore such that the expandable clip abuts the lower shoulder of the clip movement region causing the expandable clip to be compressed by the lower shoulder and the at least one groove.

4. The camshaft chain tensioner of claim 1, wherein the expandable clip is configured such that, when the first end of the expandable clip is displaced relative to the second end of the expandable clip, the expandable clip expands, and wherein the clip retention device includes a first protruding end that engages the outer side of the first end of the expandable clip and a second protruding end that engages the outer side of the second end of the expandable clip thereby preventing outward movement of the first end with respect to the second end of the expandable clip, as well as preventing the axial movement of the piston.

5. The camshaft chain tensioner of claim 1, wherein the expandable clip includes an overlapping region and is configured such that, when the first end of the expandable clip is forced relatively closer to the second end of the expandable clip, the expandable clip expands, and wherein the clip retention device includes a first protruding end that engages an inner side of the first end and the second end of the expandable clip thereby preventing inward movement of the first end with respect to the second end of the expandable clip, as well as preventing the axial movement of the piston.

6. A camshaft chain tensioner, comprising:
a piston having an exterior circumferential surface that includes a plurality of grooves, the plurality of grooves each including a minimum diameter and a maximum diameter;
an expandable clip, controlling axial movement of the piston, that includes a first end and a second end, the expandable clip being expandable from a resting diameter to an expanded diameter, wherein the resting diameter is equal to or larger than the minimum diameter and smaller than the maximum diameter, and wherein the expanded diameter is equal to or exceeds the maximum diameter; and
a clip retention device that engages the expandable clip either at an overlapping region of the expandable clip or at both the first end and the second end of the expandable clip, wherein the clip retention device engages the expandable clip such that the expandable clip is prevented from expanding to or exceeding the expanded diameter of the expandable clip.

7. The camshaft chain tensioner of claim 6, further comprising a housing that includes a piston bore wherein the piston can extend out of and retract into, wherein the piston bore includes a clip movement region comprising an upper shoulder, and wherein the expandable clip is configured so that, when engaging the piston and when not engaged by the clip retention device, the expandable clip expands to the expandable diameter when the piston is forced out of the piston bore such that the expandable clip abuts the upper shoulder of the clip movement region causing the expandable clip to be forced over a first groove of the plurality of grooves.

8. The camshaft chain tensioner of claim 7, wherein the clip movement region of the piston bore further comprises a lower shoulder such that, when the expandable clip is engaging the piston and when the expandable clip is not engaged by the clip retention device, the expandable clip is prevented from expanding to the expandable diameter when the piston is forced into the piston bore such that the expandable clip abuts the lower shoulder of the clip movement region causing the expandable clip to be compressed by the lower shoulder and a second groove of the plurality of grooves.

9. The camshaft chain tensioner of claim 6, wherein the clip retention device that engages the expandable clip at both the first end and the second end of the expandable clip, wherein the expandable clip is configured such that, when the first end of the expandable clip is displaced relative to the second end of the expandable clip, the expandable clip expands, and wherein the clip retention device includes a first protruding end that engages the outer side of the first end of the expandable clip and a second protruding end that engages the outer side of the second end of the expandable clip thereby preventing outward movement of the first end with respect to the second end of the expandable clip, as well as preventing the axial movement of the piston.

10. The camshaft chain tensioner of claim 6, wherein the clip retention device that engages the expandable clip at an overlapping region of the expandable clip, wherein the expandable clip is configured such that, when the first end of the expandable clip is forced relatively closer to the second end of the expandable clip, the expandable clip expands, and wherein the clip retention device includes a first protruding end that engages an inner side of the first end and the second end of the expandable clip thereby preventing inward movement of the first end with respect to the second end of the expandable clip, as well as preventing the axial movement of the piston.

11. A method of inhibiting axial movement of a piston of a camshaft chain tensioner, comprising:
placing an expandable clip around an exterior circumferential surface of a piston, the exterior circumferential surface including a plurality of engagement grooves among which the expandable clip is placed, wherein the expandable clip includes a first end and a second end, and wherein the expandable clip is expandable from a resting diameter to an expanded diameter; and
engaging the expandable clip with a clip retention device either at an overlapping region of the expandable clip or at both the first end region and the second end region of the expandable clip such that the expandable clip is prevented from expanding to the expanded diameter.

12. The method of claim 11, further comprising the step of removing the clip retention device after installing the hydraulically actuated camshaft chain tensioner into an engine.

13. The method of claim 12, wherein the clip retention device includes a visual indicator that visually distinguishes the clip retention device from other components of the camshaft chain tensioner.

14. The method of claim 12, further comprising attaching the camshaft chain tensioner to an internal combustion engine after the removing step.
